(19) United States
(12) Patent Application Publication
(10) Pub. No.: US 2007/0138262 A1
(43) Pub. Date: Jun. 21, 2007

(54) Electronic commerce system between a communication device and a vending machine

(75) Inventor: Kun-Hui Lai, Taipei (TW)

Correspondence Address: BACON & THOMAS, PLLC, 625 SLATERS LANE, FOURTH FLOOR, ALEXANDRIA, VA, 22314, US

(73) Assignee: INVENTEC CORPORATION, Taipei (TW)

(21) Appl. No.: 11/303,977

(22) Filed: Dec. 19, 2005

(51) Int. Cl. G06F 7/08

(52) U.S. Cl. 235/381

(57) ABSTRACT

An electronic commerce system is built between a vending machine and a communication device that permits information exchange through a network, wherein the vending machine includes a first wireless information transceiver coupled to a control system of the vending machine, and the communication device includes a second wireless information transceiver corresponding to the first wireless information transceiver and an electronic commerce software for performing the steps of receiving a transaction request information by the communication device; sending the information by the communication device to the network through the second wireless information transceiver; sending the information by the network to the first wireless information transceiver, and analyzing the information by the first wireless information transceiver to produce a purchase message; and sending the purchase message by the first wireless information transceiver to the control system, and releasing a merchandise stored in the vending machine by the control system according to the purchase message.

### FIELD OF THE INVENTION

The present invention relates to an electronic commerce system, and more particularly to an electronic commerce system that permits information exchange between a vending machine and a communication device through a network.

### BACKGROUND OF THE INVENTION

As traditional vending machines have the features of saving manpower, providing a 24-hour automatic operation, occupying small space, and selling several merchandises simultaneously, vendor machines are extensively installed at public places for consumers to make purchases.

In general, a traditional vending machine at its top surface comprises: a sample display area for displaying at least one sample and the sample display area includes a light emitting button disposed at the surface of the vending machine and under each corresponding sample; a slot for receiving coins or a note inlet for receiving dollar bills disposed at the surface of the vending machine and below the sample display area; a control system installed in the vending machine for determining the dollar amount of the coins or dollar bills received by the slot or note inlet; and a display device of the vending machine for displaying a received amount according to the coins or dollar notes received. A sellable merchandise is determined according to the received amount, and corresponding to a light emitting button disposed under the sellable sample is lit to remind consumers about the merchandises that could be bought by the received amount. The vending machine includes a plurality of storage areas for storing a plurality of merchandises corresponding to each sample, such that after the light emitting button is lit, the control system allows the merchandise in a storage area that corresponds to the light emitting button to drop from a conveying passage of the vending machine to a merchandise outlet disposed at the bottom of the vending machine. If the received amount exceeds the selling price of the merchandise, the control system will return the change automatically.

However, the traditional vending machine has the foregoing advantages and also brings many problems. For example, no one attends the traditional vending machine, and thus a vending machine may become a tempting target of a thief or damaged easily or dumped at the roadside. After the merchandises in a traditional vending machine are sold out, the merchandises cannot be refilled immediately. All of the above may cause a problem to social security or a deficiency to the business operation and management. Therefore, some vending machine manufacturers focused on the foregoing problems to develop various monitoring and management systems for the vending machines, such as that disclosed in U.S. Pat. No. 4,412,292.

As to consumers, although traditional vending machines provide many types of merchandises, a consumer cannot purchase the merchandises from the vendor machine, if the consumer does not have enough coins, or the traditional vending machine does not provide a note inlet. Therefore, some vending machine manufacturers focused on the foregoing problem to develop various vending machine electronic commerce systems that do not require consumers to put in coins or dollar bills as disclosed in R.O.C. Pat. Publication Nos. 535387 and 554298 (which has a foreign counterpart of U.S. Pat. Publication No. US2002128932 A1), wherein Pages 3 to 6 of the patent specification of R.O.C. Pat. No. 554298 list many electronic commerce systems for vending machines, but those electronic commerce systems for vending machines has a common characteristic that a transaction can be completed by dialing a number and obtaining a series of exchange messages, regardless of before or after the transaction of the vending machine electronic commerce system. Such arrangement is very inconvenient to consumers, and thus providing a simple and easy operating procedure to allow consumers to complete a transaction with the vending machine will be appreciated by the general public.

### SUMMARY OF THE INVENTION

In view of the shortcomings of the prior art, the inventor of the present invention based on years of experience to conduct extensive researches and experiments, and finally invented an electronic commerce system between a communication device and a vending machine in accordance with the present invention.

Therefore, it is a primary objective of the present invention to provide an electronic commerce system between a communication device and a vending machine, and the system is built between at least one vending machine and at least one communication device that permits information exchange with the vending machine through a network, and the vending machine includes a first wireless information transceiver, and a first information exchange unit is coupled to a control system of the vending machine, and the communication device includes a second wireless information transceiver corresponding to the first wireless information transceiver, and the communication device includes an electronic commerce software, such that after the electronic commerce software is executed, the vending machine and the communication device process as follows: The communication device receives at least one externally inputted transaction request information for a desired merchandise; the communication device sends the transaction request information to the network through the second wireless information transceiver; the network sends the transaction request information to the first wireless information transceiver, and the first wireless information transceiver analyzes the transaction request information to produce a purchase message; and the first wireless information transceiver sends the purchase message to the control system, and the control system releases a merchandise stored in the vending machine according to the purchase message.

Another objective of the present invention is to provide a vending machine for carrying out an electronic commerce transaction, and the vending machine at its surface has a first wireless information transceiver, and the first wireless information transceiver can receive a transaction request information from a communication device through a network, and the first wireless information transceiver analyzes the transaction request information to produce a purchase message, and the first wireless information transceiver sends the purchase message to a control system of the vending machine, and the control system releases a merchandise stored in the vending machine according to the purchase message.

Another objective of the present invention is to provide a communication device for carrying out an electronic commerce transaction, and the communication device includes a second wireless information transceiver corresponding to a first wireless information transceiver of the vending machine, and the communication device includes an electronic commerce software, and the communication device executes the electronic commerce software and receives at least one externally inputted transaction request information of a desired merchandise, and the communication device sends the transaction request information to a network through the second wireless information transceiver.

### BRIEF DESCRIPTION OF THE DRAWINGS

FIG. 1 is a schematic view of a system architecture of the present invention;

FIG. 2 is a flow chart of the system operation of the present invention;

FIG. 3 is a schematic view of a vending machine of the present invention; and

FIG. 4 is a schematic view of a communication device of the present invention.

### DETAILED DESCRIPTION OF THE PREFERRED EMBODIMENTS

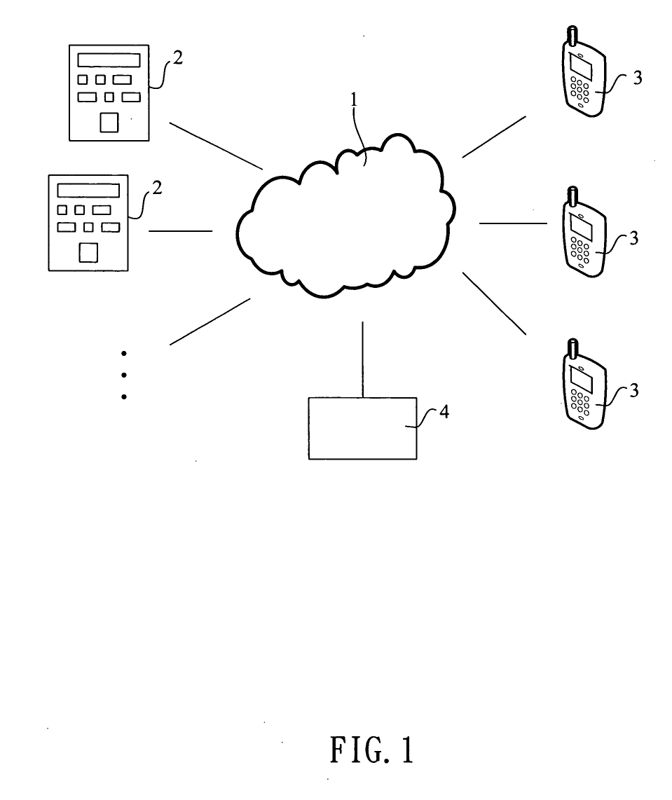

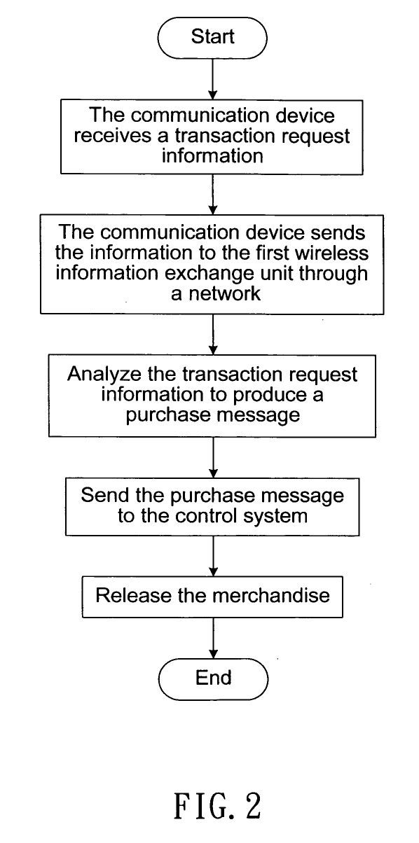

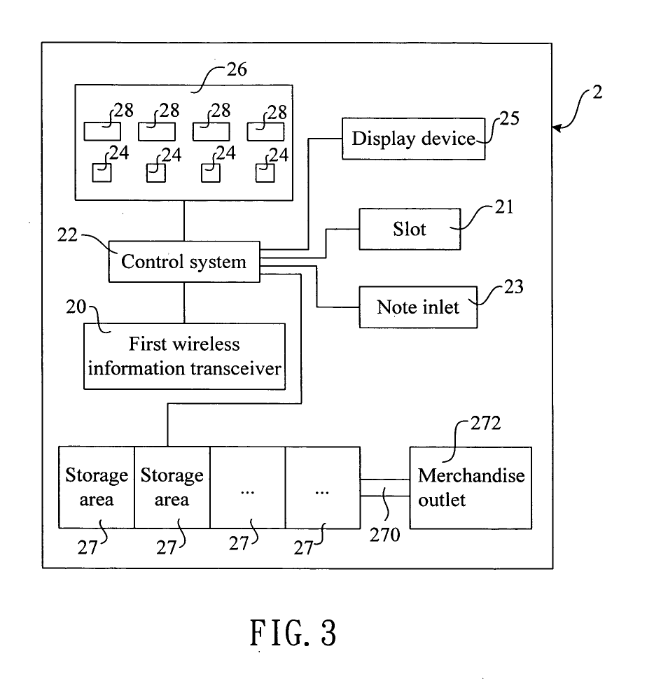

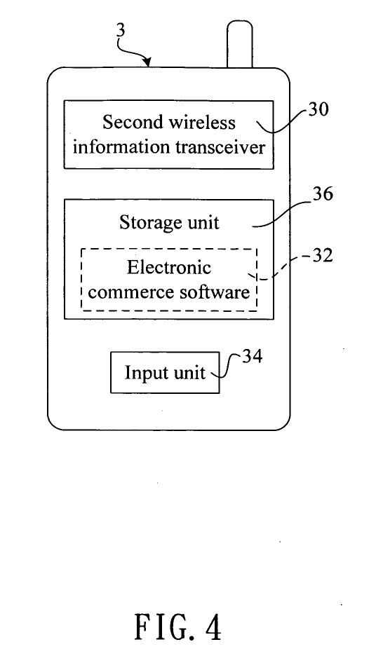

Referring to FIGS. 1 and 2 for the electronic commerce system between a communication device and a vending machine in accordance with the present invention, the system is built between at least one vending machine 2 and at least one communication device 3 that permits information exchange with the vending machine through a network 1, and the vending machine 2 includes a first wireless information transceiver 20 (as shown in FIG. 3), and the first wireless information transceiver 20 is coupled to a control system 22 of the vending machine 2, and the communication device 3 includes a second wireless information transceiver 30 (as shown in FIG. 4) corresponding to the first wireless information transceiver 20, and the communication device 3 includes an electronic commerce software 32 installed therein, such that after the electronic commerce software 32 is executed, the communication device 3 receives at least one externally inputted transaction request information of a desired merchandise. The communication device 3 sends the transaction request information to the network through the second wireless information transceiver 30, and the network 1 sends the transaction request information to the first wireless information transceiver 20. The first wireless information transceiver 20 analyzes the transaction request information to produce a purchase message, and the first wireless information transceiver 20 sends the purchase message to the control system 22, and the control system 22 releases a merchandise stored in the vending machine 2 according to the purchase message.

In the system, the electronic commerce software 32 sends out a desired transaction message to the vending machine 2 before the communication device 3 receives the transaction request information, and the vending machine 2 sends the merchandise information to the communication device 3 through the first wireless information transceiver 20 according to the merchandise message, and the electronic commerce software 32 will display various merchandise information (such as food content, calorie, and weight, etc) of each merchandise sold by the vending machine 2 according to the merchandise information.

In the system, the transaction request information inputs a number assigning signal and a confirmation message of the vending machine 2 through an input unit 34 (such as a keyboard or touch panel) of the communication device 3, and thus the electronic commerce software 32 is produced by the number assigning signal and the confirmation message, or the vending machine 2 includes a third wireless information transceiver 24 installed at a corresponding position of each sample in the display area. Each third wireless information transceiver 24 can send out a selling message. After the communication device 3 uses the second wireless information transceiver 30 to receive a selling message and a confirmation message sent from the input unit 34 of the communication device 3, the electronic commerce software 32 produces the transaction request information according to the selling message and confirmation message.

In the system, the transaction request information will be sent to a telecommunication service system 4, after the communication device 3 uses the second wireless information transceiver 30 to send the transaction request information to the network 1. The telecommunication service system 4 will record the transaction and deduct the amount, and then send the transaction request information to the first wireless information transceiver 20 through the network 1 for analyzing and producing the purchase message and further releasing a merchandise.

Referring to FIGS. 1 and 3 for the vending machine for carrying out an electronic commerce transaction in accordance with the present invention, the vending machine 2 includes a sample display area 26 disposed at the surface of the vending machine 2 for displaying at least one sample, a light emitting button 28 disposed at the surface of the vending machine 2 and under each corresponding sample in the sample display area 26, and a slot 21 for receiving coins or a note inlet 23 for receiving dollar bills disposed under the sample display area 26 at the surface of the vending machine 2. The vending machine 2 further includes a control system 22 for determining the dollar amount of the coins or dollar bills received by the slot 21 or note inlet 23, outputting a received amount on a display device 25 of the vending machine 2 according to the coins and dollar bills received, determining the sellable merchandise according to the received amount, and lighting up the light emitting button 29 disposed under the corresponding sellable sample to remind consumers about the sellable merchandise that the received amount can buy. Further, the vending machine 2 includes a plurality of storage areas 27 for separately storing a plurality of merchandises corresponding to each sample. After the lit light emitting button 28 is pressed, the control system 22 will drop the merchandise stored in the storage area 27 and corresponding to the pressed light emitting button to a merchandise outlet 272 disposed at the bottom of the vending machine 2 through a conveying passage 270 of the vending machine 2. If the received amount exceeds the selling price of the merchandise, the control system 22 will return the change automatically. The vending machine 2 includes a first wireless information exchange unit 20 installed at a position proximate to the slot 21 or the note inlet 23, such that the first wireless information exchange unit 20 can receive a transaction request information transmitted from a communication device 3 through the network 1. The first wireless information transceiver 20 analyzes the transaction request information to produce a purchase message, and the first wireless information transceiver 20 sends the purchase message to the control system 22, and the control system 22 releases a merchandise stored in the vending machine 2 according to the purchase message.

Referring to FIGS. 3 and 4 for the present invention, the vending machine 2 includes a third wireless information transceiver 24 disposed separately at a position proximate to each light emitting button 28, and each third wireless information transceiver 24 can send out a selling message. After the communication device 3 uses its second wireless information transceiver 30 to receive a selling message and a confirmation message sent from the input unit 34 of the communication device, an electronic commerce software 32 of the communication device 3 can produce the transaction request information according to the selling message and the confirmation message.

Referring to FIGS. 3 and 4 for a communication device for carrying out an electronic commerce transaction in accordance with the present invention, the communication device 3 includes a second wireless information transceiver 30 corresponding to a first wireless information transceiver 20 of the vending machine 2, and the storage unit 36 of the communication device 3 installs an electronic commerce software 32. The communication device 3 can execute the electronic commerce software 32, and receives at least one externally inputted transaction request information of a desired merchandise. The communication device 3 sends the transaction request information to a network 1 through the second wireless information transceiver 30, and the network 1 sends the transaction request information to the vending machine 2 to complete the transaction.

With the foregoing system, consumers simply input a number assigning signal and a confirmation message from the communication device to complete the transaction or the communication device receives a selling message and a confirmation message to complete the transaction. Such system needs not to go through a complicated operating process of sending messages through the electronic commerce system of a traditional vending machine, and thus making the electronic commerce system of the vending machine simpler and more convenient.

What is claimed is:

1. An electronic commerce system between a communication device and a vending machine, said system being built between at least one vending machine and at least one communication device that permits an information exchange with said vending machine through a network, and said vending machine includes a first wireless information transceiver, and said first information exchange unit is coupled to a control system of said vending machine, and said communication device includes a second wireless information transceiver corresponding to said first wireless information transceiver, and said communication device includes an electronic commerce software, such that after said electronic commerce software is executed, said vending machine and said communication device process the steps of:
said communication device receives at least one externally inputted transaction request information for a desired merchandise;
said communication device sends said transaction request information to said network through said second wireless information transceiver;
said network sends said transaction request information to said first wireless information transceiver, and said first wireless information transceiver analyzes said transaction request information to produce a purchase message; and
said first wireless information transceiver sends said purchase message to said control system, and said control system releases a merchandise stored in said vending machine according to said purchase message.

2. The system of claim 1, wherein said electronic commerce software issues a desired transaction message to said vending machine before said communication device receives said transaction request information, and then said vending machine sends a merchandise message to said communication device through said first wireless information transceiver according to said desired transaction message, and said electronic commerce software displays various merchandise information of said merchandise sold by said vending machine according to said merchandise message.

3. The system of claim 2, wherein said transaction request information inputs a number assigning signal and a confirmation message to said vending machine by an input unit of said communication device, and said electronic commerce software is produced according to said number assigning signal and said confirmation message.

4. The system of claim 2, wherein said communication device uses said second wireless information transceiver to receive said transaction request information, and said vending machine includes a third wireless information transceiver installed at a position corresponding to said each sample in said display area for sending a selling message and a confirmation message sent from said input unit of said communication device, and then said electronic commerce software is produced according to said selling message and said confirmation message.

5. The system of claim 3 or 4, wherein said communication device uses said second wireless information transceiver to send said transaction request information to said network, and then said transaction request information is sent to a telecommunication service system, and after said telecommunication service system records a transaction and deducts an amount, said transaction request information is sent to said first wireless information transceiver through said network for analyzing and producing said purchase message and releasing a merchandise.

6. A vending machine for carrying out an electronic commerce transaction, comprising:
a first wireless information transceiver, disposed at the surface of said vending machine, and capable of receiving a transaction request information transmitted from a communication device through a network, and said first wireless information transceiver analyzes said transaction request information to produce a purchase message; and
a control system, coupled to said first wireless information transceiver for receiving said purchase message from said first wireless information transceiver, and said control system releases a merchandise stored in said vending machine according to said purchase message.

7. The vending machine of claim 6, wherein said vending machine at its surface includes a third wireless information transceiver for sending out a selling message.

8. The vending machine of claim 6, further comprising:
a sample display area, disposed at the surface of said vending machine for displaying at least one sample;
a plurality of light emitting buttons, each being disposed in said sample display area on the surface of said vending machine and at a position corresponding to said each sample;
a slot, disposed on the surface of said vending machine and under said sample display area;
a plurality of storage areas, disposed in said vending machine for storing a plurality of merchandises corresponding to said samples; and
said control system can determine a specific amount of coins received from said slot, and a display device of said vending machine outputs a received amount of coins or dollar bill, and said control system can determine a sellable merchandise according to said received amount, and lights up a light emitting button corresponding to said sample of said sellable merchandise, and after said light emitting button is pressed and lit, said control system drops a merchandise stored in said storage area and corresponding to said pressed light emitting button to a merchandise outlet disposed at the bottom of said vending machine through a conveying passage of said vending machine.

9. The vending machine of claim 7, further comprising:
a sample display area, disposed at the surface of said vending machine for displaying at least one sample;
a plurality of light emitting buttons, each being disposed in said sample display area on the surface of said vending machine and at a position corresponding to said each sample;
a slot, disposed on the surface of said vending machine and under said sample display area;
a plurality of storage areas, disposed in said vending machine for storing a plurality of merchandises corresponding to said samples; and
said control system can determine a specific amount of coins received from said slot, and a display device of said vending machine outputs a received amount of coins or dollar bill, and said control system can determine a sellable merchandise according to said received amount, and lights up a light emitting button corresponding to said sample of said sellable merchandise, and after said light emitting button is pressed and lit, said control system drops a merchandise stored in said storage area and corresponding to said pressed light emitting button to a merchandise outlet disposed at the bottom of said vending machine through a conveying passage of said vending machine.

10. A communication device for carrying out an electronic commerce transaction, comprising:
a storage unit, including an electronic commerce software installed therein; and
a second wireless information transceiver, corresponding to a first wireless information transceiver of a vending machine, such that after said electronic commerce software is executed, said second wireless information transceiver can receive at least one externally inputted transaction request information of a desired merchandise, and said communication device sends said transaction request information to a network through said second wireless information transceiver.
